(19) United States
(12) Patent Application Publication
(10) Pub. No.: US 2020/0034665 A1
(43) Pub. Date: Jan. 30, 2020

(54) DETERMINING VALIDITY OF MACHINE LEARNING ALGORITHMS FOR DATASETS

(71) Applicant: DataRobot, Inc., Boston, MA (US)

(72) Inventors: SINDHU GHANTA, San Mateo, CA (US); DREW ROSELLI, Woodinville, WA (US); NISHA TALAGALA, Saratoga, CA (US); VINAY SRIDHAR, San Jose, CA (US); SWAMINATHAN SUNDARARAMAN, San Jose, CA (US); LIOR AMAR, Sunnyvale, CA (US); LIOR KHERMOSH, Palo Alto, CA (US); BHARATH RAMSUNDAR, Fremont, CA (US); SRIRAM SUBRAMANIAN, Dallas, TX (US)

(73) Assignee: DataRobot, Inc., Boston, MA (US)

(21) Appl. No.: 16/049,647

(22) Filed: Jul. 30, 2018

(51) Int. Cl. G06K 9/62; G06K 9/03; G06N 99/00; G06N 5/04; G06F 17/18

(52) U.S. Cl. CPC G06K 9/6262; G06K 9/03; G06F 17/18; G06N 5/04; G06N 99/005

(57) ABSTRACT

Apparatuses, systems, program products, and methods are disclosed for determining validity of machine learning algorithms for datasets. An apparatus includes a primary training module that is configured to train a first machine learning model for a first machine learning algorithm. An apparatus includes a primary validation module that is configured to validate a first machine learning model to generate an error data set. An apparatus includes a secondary training module that is configured to train a second machine learning model for a second machine learning algorithm using an error data set. A second machine learning algorithm may be configured to predict a suitability of a first machine learning model for analyzing an inference data set. An apparatus includes an action module that is configured to trigger an action in response to a predicted suitability of the first machine learning model not satisfying a predetermined suitability threshold.

### FIELD

This invention relates to machine learning and more particularly relates to determining the suitability of a machine learning algorithm for analyzing an inference data set using an auxiliary machine learning algorithm.

### BACKGROUND

Machine learning is being integrated into a wide range of use cases and industries. Unlike other types of applications, machine learning (including deep learning and advanced analytics) has multiple independent running components that must operate cohesively to deliver accurate and relevant results. Furthermore, slight changes to input data can cause non-linear changes in the results. This inherent complexity makes it difficult to manage or monitor all the interdependent aspects of a machine learning system.

### SUMMARY

Apparatuses, systems, program products, and method are disclosed for determining validity of machine learning algorithms for datasets. In one embodiment, an apparatus includes a primary training module that is configured to train a first machine learning model for a first machine learning algorithm using a training data set. An apparatus, in certain embodiments, includes a primary validation module that is configured to validate a first machine learning model using a validation data set. Output of a validation of a first machine learning model may comprise an error data set. An apparatus, in some embodiments, includes a secondary training module that is configured to train a second machine learning model for a second machine learning algorithm using an error data set. A second machine learning algorithm may be configured to predict a suitability of a first machine learning model for analyzing an inference data set. In one embodiment, an apparatus includes an action module that is configured to trigger an action associated with a first machine learning algorithm in response to a predicted suitability of the first machine learning model for analyzing an inference data set not satisfying a predetermined suitability threshold.

A method for determining validity of machine learning algorithms for datasets, in one embodiment, includes training a first machine learning model for a first machine learning algorithm using a training data set. A method, in certain embodiments, includes validating the first machine learning model using a validation data set. Output of a validation of a first machine learning model may comprise an error data set. A method, in some embodiments, includes training a second machine learning model for a second machine learning algorithm using an error data set. A second machine learning algorithm may be configured to predict a suitability of a first machine learning model for analyzing an inference data set. In one embodiment, a method includes triggering an action associated with a first machine learning algorithm in response to a predicted suitability of the first machine learning model for analyzing an inference data set not satisfying a predetermined suitability threshold.

In one embodiment, an apparatus for determining validity of machine learning algorithms for datasets includes means for training a first machine learning model for a first machine learning algorithm using a training data set. An apparatus, in certain embodiments, includes means for validating a first machine learning model using a validation data set. Output of a validation of a first machine learning model may comprise an error data set. An apparatus, in some embodiments, includes means for training a second machine learning model for a second machine learning algorithm using an error data set. A second machine learning algorithm may be configured to predict a suitability of a first machine learning model for analyzing an inference data set. In one embodiment, an apparatus includes means for triggering an action associated with the first machine learning algorithm in response to the predicted suitability of the first machine learning model for analyzing the inference data set not satisfying a predetermined suitability threshold.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for determining validity of machine learning algorithms for datasets;

FIG. 2A is a schematic block diagram illustrating one embodiment of a logical machine learning layer for determining validity of machine learning algorithms for datasets;

FIG. 2B is a schematic block diagram illustrating another embodiment of a logical machine learning layer for determining validity of machine learning algorithms for datasets;

FIG. 2C is a schematic block diagram illustrating a certain embodiment of a logical machine learning layer for determining validity of machine learning algorithms for datasets;

FIG. 3 is a schematic block diagram illustrating one embodiment of an apparatus for determining validity of machine learning algorithms for datasets;

FIG. 4 is a schematic flow chart diagram illustrating one embodiment of a method for determining validity of machine learning algorithms for datasets; and

FIG. 5 is a schematic flow chart diagram illustrating another embodiment of a method for determining validity of machine learning algorithms for datasets.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

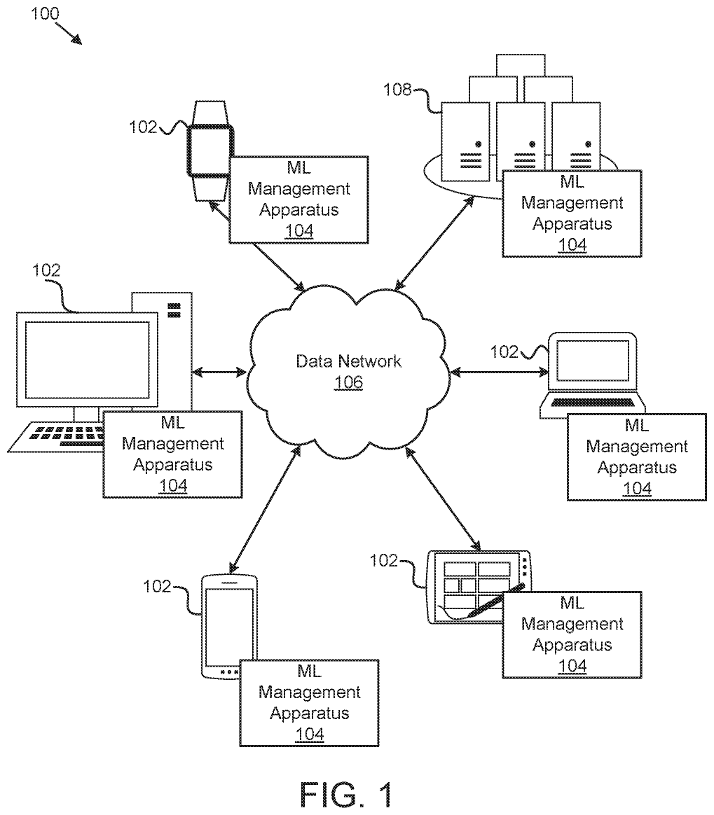

FIG. 1 is a schematic block diagram illustrating one embodiment of a system 100 for determining validity of machine learning algorithms for datasets. In one embodiment, the system 100 includes one or more information handling devices 102, one or more ML management apparatuses 104, one or more data networks 106, and one or more servers 108. In certain embodiments, even though a specific number of information handling devices 102, ML management apparatuses 104, data networks 106, and servers 108 are depicted in FIG. 1, one of skill in the art will recognize, in light of this disclosure, that any number of information handling devices 102, ML management apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include executable code, functions, instructions, operating systems, and/or the like for performing various machine learning operations, as described in more detail below.

In one embodiment, the ML management apparatus 104 is configured to manage, monitor, maintain, and/or the like the “health” of a machine learning system. As used herein, the “health” of a machine learning system may refer to the suitability, validity, or predictive performance of a machine learning algorithm or model, that is trained on a training data set, for analyzing an inference data set (e.g., the capability of the first machine learning algorithm/model to generate accurate predictions for an inference data set) that is processed using the machine learning model based on an analysis of the machine learning algorithm or model using a secondary or auxiliary machine learning algorithm.

As explained in more detail below, a machine learning system may involve various components, pipelines, data sets, and/or the like—such as training pipelines, orchestration/management pipelines, inference pipelines, and/or the like. Furthermore, components may be specially designed or configured to handle specific objectives, problems, and/or the like. In some machine learning systems, a user may be required to determine which machine learning components are necessary to analyze a particular problem/objective, and then manually determine the inputs/outputs for each of the components, the limitations of each component, events generated by each component, and/or the like. Furthermore, with some machine learning systems, it may be difficult to track down where an error occurred, what caused an error, why the predicted results weren't as accurate as they should be, whether the machine learning model is suitable for a particular inference data set, and/or the like, due to the numerous components and interactions within the system.

In one embodiment, the ML management apparatus 104 provides an improvement for machine learning systems by training a first or primary machine learning model for a first/primary machine learning algorithm using a training data set, validating the first machine learning model using a validation data set, the output of which is an error data set that describes the accuracy of the first machine learning model on the validation data set, and training a second machine learning model for a second/auxiliary machine learning algorithm using the error data set. The second machine learning algorithm is then used to predict, verify, validate, check, monitor, and/or the like the efficacy, accuracy, reliability, and/or the like of the first or primary machine learning model that is used to analyze an inference data set.

If the second machine learning model, for example, predicts that the first machine learning algorithm or model is not a good fit for the inference data set, as indicated by one or more health or suitability scores, then the ML management apparatus 104 may take one or more actions, steps, functions, and/or the like to correct or improve the first machine learning model. For instance, if the health/suitability score satisfies an unsuitability threshold, indicating that the first machine learning model used to analyze the inference data set is not suitable for the inference training data, the ML management apparatus 104 may change the machine learning model, may retrain the machine learning model, may provide recommendations for generating a more accurate machine learning model, may adjust or update various thresholds or parameters of the machine learning model, and/or the like.

Furthermore, the ML management apparatus 104 may determine the suitability of a first machine learning model of a first machine learning algorithm for analyzing an inference data set using a second machine learning model of a second machine learning algorithm at any point in the machine learning system. For example, if the machine learning system is a deep learning system that includes multiple inference layers, the ML management apparatus 104 may determine how suitable the first machine learning model is for the inference data set by evaluating the suitability of the first machine learning model using the second machine learning model at each layer of the deep learning system.

In certain embodiments of machine learning systems 200, there is a training phase, for generating the machine learning model, and an inference phase for analyzing an inference data set using the machine learning model. The output from the inference phase may be one or more predictive “labels” determined as a function of one or more features of the inference data set. For example, if the training data set comprises three columns of feature data—Age, Sex, and Height—that are used to train the machine learning model, and the inference data comprises two columns of feature data—Age and Height—the output from an inference pipeline 206 using the machine learning model may be a “label” describing the predicted Sex (M/F) based on the given inference data.

In such an embodiment, labels may be required to determine the suitability of the machine learning model, e.g., the accuracy or predictive performance of the machine learning model, to an inference data set during the inference phase. The predictive performance is usually evaluated on either the training data set or a separate validation or test set where both the feature and label information is available, which does not allow for determining or estimating the predictive performance of the machine learning model is real-time during or prior to the inference phase. Furthermore, waiting for labels to be generated in order to validate the efficacy of a machine learning model may delay the analysis, which can cause business loses or other issue when the predictive performance of the machine learning model deviates or drops.

The ML management apparatus 104, in one embodiment, however, evaluates the suitability (predictive performance) of a machine learning model, machine learning algorithm, and/or the like in the absence of labels, and is agnostic of the type of problem and algorithm used, the particular language or framework used, and/or the like by extracting statistics from features in the training data set and the inference data set, and using the statistics to evaluate how applicable the training data set is likely to be to the inference data set by generating a suitability score, as explained in more detail below.

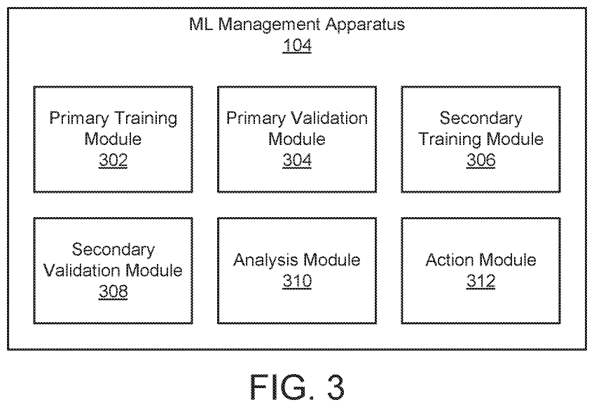

The ML management apparatus 104, including its various sub-modules, may be located on one or more information handling devices 102 in the system 100, one or more servers 108, one or more network devices, and/or the like. The ML management apparatus 104 is described in more detail below with reference to FIG. 3.

In various embodiments, the ML management apparatus 104 may be embodied as a hardware appliance that can be installed or deployed on an information handling device 102, on a server 108, or elsewhere on the data network 106. In certain embodiments, the ML management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the ML management apparatus 104 may include a power interface, a wired and/or wireless network interface, a graphical interface that attaches to a display, and/or a semiconductor integrated circuit device as described below, configured to perform the functions described herein with regard to the ML management apparatus 104.

The ML management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the ML management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the ML management apparatus 104.

The semiconductor integrated circuit device or other hardware appliance of the ML management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the ML management apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The one or more servers 108 may store data associated with an information handling device 102, such as machine learning data, algorithms, training models, and/or the like.

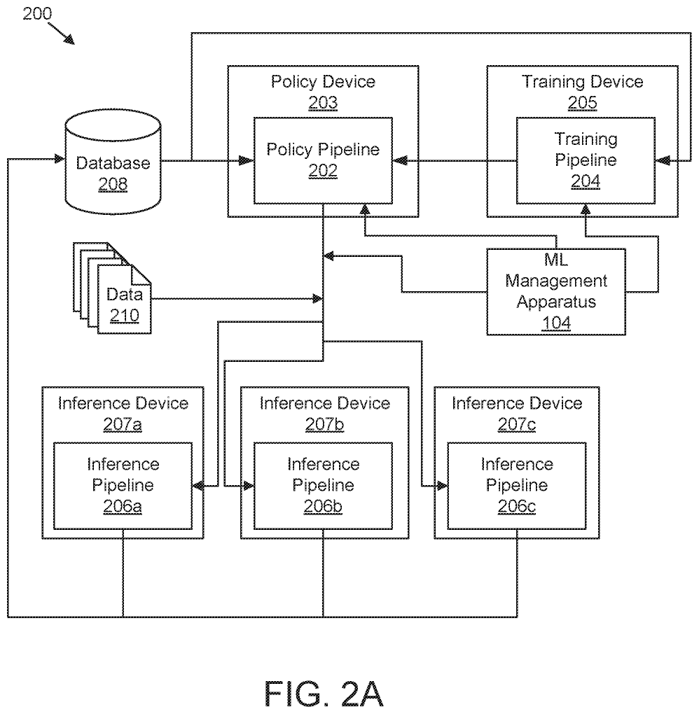

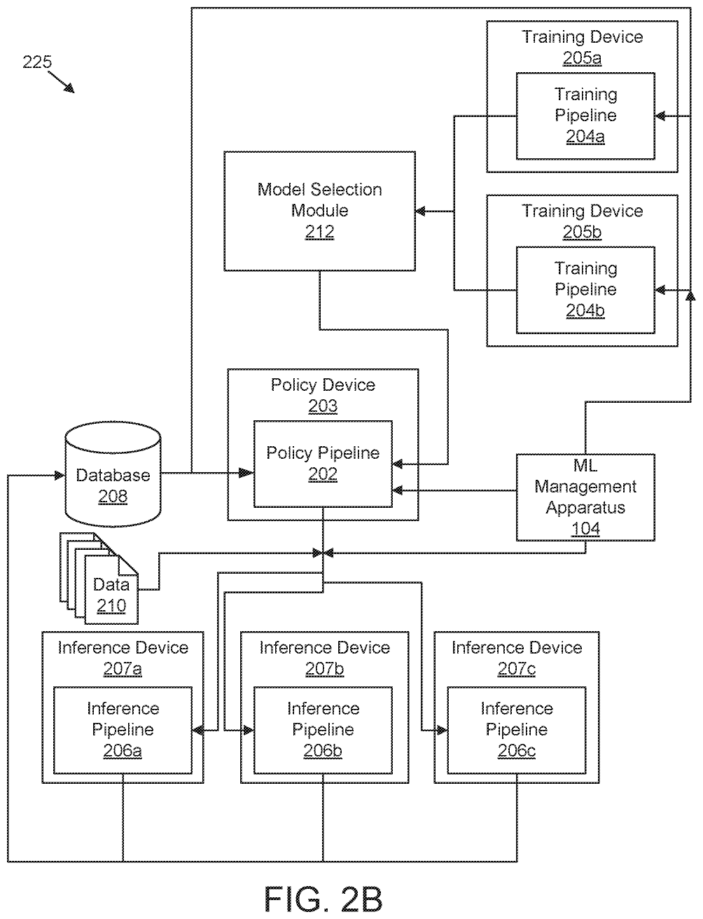

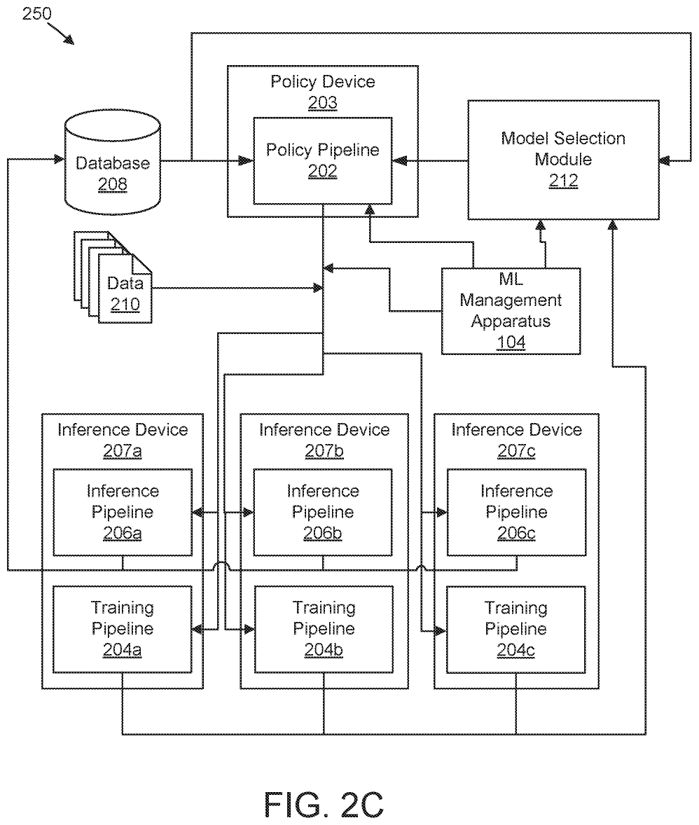

FIG. 2A is a schematic block diagram illustrating one embodiment of a machine learning system 200 for determining validity of machine learning algorithms for datasets. In one embodiment, the logical machine learning layer 200 includes one or more policy/control pipelines 202, one or more training pipelines 204, one or more inference pipelines 206a-c, one or more databases 208, input data 210, and an ML management apparatus 104. Even though a specific number of machine learning pipelines 202, 204, 206a-c are depicted in FIG. 2A, one of skill in the art, in light of this disclosure, will recognize that any number of machine learning pipelines 202, 204, 206a-c may be present in the logical machine learning layer 200. Furthermore, as depicted in FIG. 2A, the various pipelines 202, 204, 206a-c may be located on different nodes embodied as devices 203, 205, 207a-c such as information handling devices 102 described above, virtual machines, cloud or other remote devices, and/or the like. In some embodiments, the machine learning system 200 includes an embodiment of a logical machine learning layer, also known as an intelligence overlay network (“ION”).

As used herein, machine learning pipelines 202, 204, 206a-c comprise various machine learning features, components, objects, modules, and/or the like to perform various machine learning operations such as algorithm training/inference, feature engineering, validations, scoring, and/or the like. Pipelines 202, 204, 206a-c may analyze or process data 210 in batch, e.g., process all the data at once from a static source, streaming, e.g., operate incrementally on live data, or a combination of the foregoing, e.g., a micro-batch.

In certain embodiments, each pipeline 202, 204, 206a-c executes on a device 203, 205, 207a-c, e.g., an information handling device 102, a virtual machine, and/or the like. In some embodiments, multiple different pipelines 202, 204, 206a-c execute on the same device. In various embodiments, each pipeline 202, 204, 206a-c executes on a distinct or separate device. The devices 203, 205, 207a-c may all be located at a single location, may be connected to the same network, may be located in the cloud or another remote location, and/or some combination of the foregoing.

In one embodiment, each pipeline 202, 204, 206a-c is associated with an analytic engine and executes on a specific analytic engine type for which the pipeline is 202, 204, 206a-c configured. As used herein, an analytic engine comprises the instructions, code, functions, libraries, and/or the like for performing machine learning numeric computation and analysis. Examples of analytic engines may include Spark, Flink, TensorFlow, Caffe, Theano, and PyTorch. Pipelines 202, 204, 206a-c developed for these engines may contain components provided in modules/libraries for the particular analytic engine (e.g., Spark-ML/MLlib for Spark, Flink-ML for Flink, and/or the like). Custom programs may also be included that are developed for each analytic engine using the application programming interface for the analytic engine (e.g., DataSet/DataStream for Flink). Furthermore, each pipeline may be implemented using various different platforms, libraries, programming languages, and/or the like. For instance, an inference pipeline 206a may be implemented using Python, while a different inference pipeline 206b is implemented using Java.

In one embodiment, the machine learning system 200 includes physical and/or logical groupings of the machine learning pipelines 202, 204, 206a-c based on a desired objective, result, problem, and/or the like. For instance, the ML management apparatus 104 may select a training pipeline 204 for generating a machine learning model configured for the desired objective and one or more inference pipelines 206a-c that are configured to analyze the desired objective by processing input data 210 associated with the desired objective using the analytic engines for which the selected inference pipelines 206a-c are configured for and the machine learning model. Thus, groups may comprise multiple analytic engines, and analytic engines may be part of multiple groups. Groups can be defined to perform different tasks such as analyzing data for an objective, managing the operation of other groups, monitoring the results/performance of other groups, experimenting with different machine learning algorithms/models in a controlled environment, e.g., sandboxing, and/or the like.

For example, a logical grouping of machine learning pipelines 202, 204, 206a-c may be constructed to analyze the results, performance, operation, health, and/or the like of a different logical grouping of machine learning pipelines 202, 204, 206a-c by processing feedback, results, messages, and/or the like from the monitored logical grouping of machine learning pipelines 202, 204, 206a-c and/or by providing inputs into the monitored logical grouping of machine learning pipelines 202, 204, 206a-c to detect anomalies, errors, and/or the like.

Because the machine learning pipelines 202, 204, 206a-c may be located on different devices 203, 205, 207a-c, the same devices 203, 205, 207a-c, and/or the like, the ML management apparatus 104 logically groups machine learning pipelines 202, 204, 206a-c that are best configured for analyzing the objective. As described in more detail below, the logical grouping may be predefined such that a logical group of machine learning pipelines 202, 204, 206a-c may be particularly configured for a specific objective.

In certain embodiments, the ML management apparatus 104 dynamically selects machine learning pipelines 202, 204, 206a-c for an objective when the objective is determined, received, and/or the like based on the characteristics, settings, and/or the like of the machine learning pipelines 202, 204, 206a-c. In certain embodiments, the multiple different logical groupings of pipelines 202, 204, 206a-c may share the same physical infrastructure, platforms, devices, virtual machines, and/or the like. Furthermore, the different logical groupings of pipelines 202, 204, 206a-c may be merged, combined, and/or the like based on the objective being analyzed.

In one embodiment, the policy pipeline 202 is configured to maintain/manage the operations within the logical machine learning layer 200. In certain embodiments, for instance, the policy pipeline 202 receives machine learning models from the training pipeline 204 and pushes the machine learning models to the inference pipelines 206a-c for use in analyzing the input data 210 for the objective. In various embodiments, the policy pipeline 202 receives user input associated with the logical machine learning layer 200, receives event and/or feedback information from the other pipelines 204, 206a-c, validates machine learning models, facilitates data transmissions between the pipelines 202, 204, 206a-c, and/or the like.

In one embodiment, the policy pipeline 202 comprises one or more policies that define how pipelines 204, 206a-c interact with one another. For example, the training pipeline 204 may output a machine learning model after a training cycle has completed. Several possible policies may define how the machine learning model is handled. For example, a policy may specify that the machine learning model can be automatically pushed to inference pipelines 206a-c while another policy may specify that user input is required to approve a machine learning model prior to the policy pipeline 202 pushing the machine learning model to the inference pipelines 206a-c. Policies may further define how machine learning models are updated.

For instance, a policy may specify that a machine learning model be updated automatically based on feedback, e.g., based machine learning results received from an inference pipeline 206a-c; a policy may specify whether a user is required to review, verify, and/or validate a machine learning model before it is propagated to inference pipelines 206a-c; a policy may specify scheduling information within the logical machine learning layer 200 such as how often a machine learning model is update (e.g., once a day, once an hour, continuously, and/or the like); and/or the like.

Policies may define how different logical groups of pipelines 202, 204, 206a-c interact or cooperate to for a cohesive data intelligence workflow. For instance, a policy may specify that the results generated by one logical machine learning layer 200 be used as input into a different logical machine learning layer 200, e.g., as training data for a machine learning model, as input data 210 to an inference pipeline 206a-c, and/or the like. Policies may define how and when machine learning models are updated, how individual pipelines 202, 204, 206a-c communicate and interact, and/or the like.

In one embodiment, the policy pipeline 202 maintains a mapping of the pipelines 204, 206a-c that comprise the logical grouping of pipelines 204, 206a-c. The policy pipeline may further adjust various settings or features of the pipelines 204, 206a-c in response to user input, feedback or events generated by the pipelines 204, 206a-c, and/or the like. For example, if an inference pipeline 206a generates machine learning results that are inaccurate, the policy pipeline 202 may receive a message from the inference pipeline 202 that indicates the results are inaccurate, and may direct the training pipeline 204 to generate a new machine learning model for the inference pipeline 206a.

The training pipeline 204, in one embodiment, is configured to generate a machine learning model for the objective that is being analyzed based on historical or training data that is associated with the objective. As used herein, a machine learning model is generated by executing a training or learning algorithm on historical or training data associated with a particular objective. The machine learning model is the artifact that is generated by the training process, which captures patterns within the training data that map the input data to the target, e.g., the desired result/prediction. In one embodiment, the training data may be a static data set, data accessible from an online source, a streaming data set, and/or the like.

The inference pipelines 206a-c, in one embodiment, use the generated machine learning model and the corresponding analytics engine to generate machine learning results/predictions on input/inference data 210 that is associated with the objective. The input data may comprise data associated with the objective that is being analyzed, but was not part of the training data, e.g., the patterns/outcomes of the input data are not known. For example, if a user wants to know whether an email is spam, the training pipeline 204 may generate a machine learning model using a training data set that includes emails that are known to be both spam and not spam. After the machine learning model is generated, the policy pipeline 202 pushes the machine learning model to the inference pipelines 206a-c, where it is used to predict whether one or more emails, e.g., provided as input/inference data 210, are spam.

Thus, as depicted in FIG. 2A, a policy pipeline 202, a training pipeline 204 and inference pipelines 206a-c are depicted in an edge/center graph. In the depicted embodiment, new machine learning models are periodically trained in a batch training pipeline 204, which may execute on a large clustered analytic engine in a data center. As the training pipeline 204 generates new machine learning models, an administrator may be notified. The administrator may review the generated machine learning models, and if the administrator approves, the machine learning models are pushed to the inference pipelines 206a-c that comprise the logical pipeline grouping for the objective, each of which is executing on live data coming from an edge device, e.g., input/inference data 210.

FIG. 2B is a schematic block diagram illustrating another embodiment of a logical machine learning layer 225 for determining validity of machine learning algorithms for datasets. In one embodiment, the logical machine learning layer 225 of FIG. 2B is substantially similar to the logical machine learning layer 200 depicted in FIG. 2A. In addition to the elements of the logical machine learning layer 200 depicted in FIG. 2A, the logical machine learning layer 225 of FIG. 2B includes a plurality of training pipelines 204a-b, executing on training devices 205a-b.

In the depicted embodiment, the training pipelines 204a-b generate machine learning models for an objective, based on training data for the objective. The training data may be different for each of the training pipelines 204a-b. For instance, the training data for a first training pipeline 204a may include historical data for a predefined time period while the training data for a second training pipeline 204b may include historical data for a different predefined time period. Variations in training data may include different types of data, data collected at different time periods, different amounts of data, and/or the like.

In other embodiments, the training pipelines 204a-b may execute different training or learning algorithms on different or the same sets of training data. For instance, the first training pipeline 204a may implement a training algorithm TensorFlow using Python, while the second training pipeline 204b implements a different training algorithm in Spark using Java, and/or the like.

In one embodiment, the logical machine learning layer 225 includes a model selection module 212 that is configured to receive the machine learning models that the training pipelines 204a-b generate and determine which of the machine learning models is the best fit for the objective that is being analyzed. The best-fitting machine learning model may be the machine learning model that produced results most similar to the actual results for the training data (e.g., the most accurate machine learning model), the machine learning model that executes the fastest, the machine learning model that requires the least amount of configuration, and/or the like.

In one embodiment, the model selection module 212 performs a hyper-parameter search to determine which of the generated machine learning models is the best fit for the given objective. As used herein, a hyper-parameter search, optimization, or tuning is the problem of choosing a set of optimal hyper-parameters for a learning algorithm. In certain embodiments, the same kind of machine learning model can require different constraints, weights, or learning rates to generalize different data patterns. These measures may be called hyper-parameters, and may be tuned so that the model can optimally solve the machine learning problem. Hyper-parameter optimization finds a set of hyper-parameters that yields an optimal machine learning model that minimizes a predefined loss function on given independent data. In certain embodiments, the model selection module 212 combines different features of the different machine learning models to generate a single combined model. In one embodiment, the model selection module 212 pushes the selected machine learning model to the policy pipeline 202 for propagation to the inference pipelines 206a-c. In various embodiments, the model selection module 212 is part of, communicatively coupled to, operatively coupled to, and/or the like the ML management apparatus 104.

FIG. 2C is a schematic block diagram illustrating a certain embodiment of a logical machine learning layer 250 for determining validity of machine learning algorithms for datasets. In one embodiment, the logical machine learning layer 250 of FIG. 2C is substantially similar to the logical machine learning layers 200, 225 depicted in FIGS. 2A and 2B, respectively. In further embodiments, FIG. 2C illustrates a federated learning embodiment of the logical machine learning layer 250.

In a federated machine learning system, in one embodiment, the training pipelines 204a-c are located on the same physical or virtual devices as the corresponding inference pipelines 206a-c. In such an embodiment, the training pipelines 204a-c generate different machine learning models and send the machine learning models to the model selection module 212, which determines which machine learning model is the best fit for the logical machine learning layer 250, as described above, or combines/merges the different machine learning models, and/or the like. The selected machine learning model is pushed to the policy pipeline 202, for validation, verification, or the like, which then pushes it back to the inference pipelines 206a-c.

FIG. 3 is a schematic block diagram illustrating one embodiment of an apparatus 300 for determining validity of machine learning algorithms for datasets. In one embodiment, the apparatus 300 includes an embodiment of an ML management apparatus 104. The ML management apparatus 104, in one embodiment, includes one or more of a primary training module 302, a primary validation module 304, a secondary training module 306, a secondary validation module 308, an analysis module 310, and an action module 312, which are described in more detail below.

In one embodiment, the primary training module 302 is configured to train a first machine learning model for a first machine learning algorithm using a training data set. In such an embodiment, the first machine learning algorithm may be any one of several available machine learning algorithms such as linear regression, logistic regression, linear discriminant analysis (“LDA”), classification and regression tress, naive bayes, K-nearest neighbors, learning vector quantization, support vector machines, bagging and random forest, boosting, and/or the like. The first machine learning algorithm may be selected based on whether the training data set comprises continuous labels or classification labels. The first machine learning algorithm, in certain embodiments, may comprise an ensemble or combination of various machine learning algorithms.

In one embodiment, the primary training module 302 trains the first machine learning model for the first machine learning algorithm on a training data set. For instance, the primary training module 302 may receive, read, access, and/or the like a training data set and provide the training data set to a training pipeline 204 to train the machine learning model. In such an embodiment, the training data set includes labels that allow the first machine learning model to “learn” from the data to perform predictions on an inference data set that does not include labels. For example, the training data set may include various data points for dogs such as weight, height, gender, breed, etc. The primary training module 302 may train the machine learning model using the dog training data set so that it can be used to predict various characteristics of the dog such as a dog's weight, gender, breed, and/or the like using an inference data set that does not include labels for the features that are being predicted.

In one embodiment, the primary validation module 304 is configured to validate the first machine learning algorithm/model using a validation data set. The validation data set, in one embodiment, comprises a data set that includes labels for various features so that when the first machine learning algorithm/model analyzes the validation data set, the predictions that the first machine learning algorithm/model generates can be compared against the labels in the validation data set to determine the accuracy of the predictions.

The resulting output of the validation of the first machine learning algorithm/model, in one embodiment, comprises an error data set. The error data set, in certain embodiments, includes values indicating the prediction error of the first machine learning algorithm/model on the validation data set (e.g., a rate, a score, or other value that indicates how often the first machine learning algorithm/model accurately predicted a label for the validation data set).

In one embodiment, the error data set includes labels that include errors generated from the predictions of the first machine learning algorithm/model on the validation data set where the errors are values indicating pass/fail criteria for the first machine learning algorithm/model (such as the terms pass/fail, a 1 or 0 value, and/or real numbers that are indicative of pass/fail given a predefined threshold). In further embodiments, the error data set includes features that comprise one or more of features of the error data set, statistical signature scores of each sample in the error data set, prediction values generated by the first machine learning algorithm/model, confidence metrics associated with predictions of the first machine learning algorithm/model, and/or one or more parameters specific to the first machine learning model.

For example, a validation data set that includes categorical data may have six classes corresponding to human activity such as walking, standing, sleeping, etc. The features for this dataset may be values collected from a smart device such as a fitness tracker, a smart phone, or the like. The primary training module 302, in one embodiment, trains the first machine learning algorithm/model on these features and labels using the training data set. The primary validation module 304, in some embodiments, uses a validation data set that includes the same features, but different data, to predict the labels using the first machine learning algorithm/model. The primary validation module 304 may compare the predictions made by the algorithm to the true label of the test data to calculate the error rate, score, weight, or other value.

In certain embodiments, in the case of data that includes continuous labels (e.g., real numbers), which may be analyzed using a regression or other continuous machine learning algorithm, the primary validation module 304 may determine pass/fail criteria for the first machine learning algorithm (note that this is trivial for data that includes classification labels because a fail is determined when the prediction of the first machine learning algorithm/model does not match the label of the validation data set).

The predictive performance of a regression, or the like, algorithm may be measured as the distance of the predicted value from the true label. The lower this distance/error is, the more accurate the predictive performance of the first machine learning algorithm may be. A threshold may be set on this error value to determine the pass/fail criterion. When the distance is lower than this threshold, for example, the label is pass and fail otherwise. These may form the labels for the error data set that the second machine learning algorithm uses for training. The value of this threshold value may be dataset dependent. Furthermore, the threshold parameter may be customizable, e.g., may be set by a user. In one embodiment, the primary validation module 304 calculates a default threshold value that is adapted to the dataset.

For example, the primary validation module 304 may calculate a regression error characteristic (“REC”) curve using the first machine learning algorithm. The “knee” of the curve is chosen to be the threshold value, which may be determined using the double differential of the REC curve. The point whose neighbors are both greater (in the double differential REC curve) may be chosen, and its corresponding x-axis value may become the default threshold value for the pass/fail criteria.

In one embodiment, the secondary training module 306 is configured to train a second machine learning model for a second machine learning algorithm using the error data set described above. The second machine learning algorithm may be configured to predict a suitability of the first machine learning algorithm/model for analyzing an inference data set. As used herein, the suitability may comprise a value such as a health score that describes the efficacy, accuracy, effectiveness, or the like of the predictions that the first machine learning algorithm/model generates for the inference data set.

In one embodiment, the second machine learning algorithm is different than the first machine learning algorithm. For example, if the first machine learning algorithm is a linear regression algorithm, the second machine learning algorithm may comprise a logistic regression algorithm. In certain embodiments, the first and second machine learning algorithms are the same machine learning algorithms. One of skill in the art will recognize a second machine learning algorithm that is suitable for assessing the suitability of the first machine learning algorithm for making predictions on an inference data set.

In one embodiment, the secondary training module 306 enhances the error data set by including additional data to supplement the prediction error data. For instance, the secondary training module 306 may include data for additional features such as features of the data set itself (e.g., the secondary training module 306 may select all or a subset of the available features of the error data set itself), statistical signature scores for each sample in the data set (e.g., a statistical score that is calculated using statistical algorithms for statistically describing a data set), prediction values from the first machine learning algorithm (e.g., the predicted values output from analyzing the inference data set using the first machine learning algorithm/model), confidence metrics associated with the predictions of the first machine learning algorithm/model, parameters that are specific to the first machine learning algorithm/model, and/or the like.

In one embodiment, the secondary validation module 308 is configured to determine a suitability of the second machine learning algorithm for predicting the suitability of the first machine learning algorithm. For instance, the secondary validation module 308 may analyze the second machine learning algorithm using a confusion matrix. As used herein, a confusion matrix (also known as an error matrix) is a specific table layout that allows visualization of the performance of an algorithm. In machine learning, a confusion matrix is a table with two rows and two columns that reports the number of false positives, false negatives, true positives, and true negatives.

In further embodiments, the secondary validation module 308 analyzes other statistics, such as training statistics, to determine the suitability of the second machine learning algorithm in accurately assessing the effectiveness of the first machine learning algorithm. The other statistics may include confidence metrics, accuracy metrics, precision metrics, and/or the like. Threshold values may be predefined to determine whether the metrics satisfy a predetermined value to indicate the suitability of the second machine learning algorithm. For example, the secondary validation module 308 may verify that the values in the confusion matrix satisfy predefined thresholds for each of the false positives, false negatives, true positives, and true negative values. One of skill in the art will recognize, in light of this disclosure, various statistical measures that may be used to assess the suitability of the second machine learning algorithm.

In certain embodiments, the secondary validation module 308 determines the suitability of an ensemble of second machine learning algorithms (e.g., a combination of two or more machine learning algorithms) for predicting the performance or accuracy of the predictions of the first machine learning algorithm for an inference data set. The secondary validation module 308, in one embodiment, may generate ensembles that include different combinations of machine learning algorithms/models to determine which ensemble is the best fit or satisfies a suitability threshold for analyzing the predictive performance of the first machine learning algorithm/model. In such an embodiment, the secondary training module 306 may be configured to train a plurality of different second machine learning models on different training data, and generate various ensembles of second machine learning models.

In one embodiment, the second machine learning algorithm/model analyzes the predictive performance of the first machine learning algorithm/model after the first machine learning algorithm/model analyzes the inference data set so that the predictions that the first machine learning algorithm/model generates can be used as input into the training of the second machine learning model, along with the error data. In certain embodiments, if the second machine learning model has already been trained, the first and second machine learning algorithms/models may run substantially simultaneously based on the inference data set to determine the predictive performance of the first machine learning algorithm/model in real-time, or substantially in real-time.

The analysis module 310, in one embodiment, is configured to determine whether the first machine learning algorithm/model is a suitable algorithm/model for generating predictions for the inference data set based on the predictions that the second machine learning algorithm generates. For instance, the analysis module 310 may analyze the various metrics, health scores, error rates, confusion matrix values, and/or the like to generate a suitability value and determine whether the suitability value satisfies a predefined threshold. For example, the analysis module 310 may determine whether the various metrics/health scores each satisfy a threshold value, if a percentage of the metrics/health scores satisfy threshold values, of if a calculated combination of various health scores (e.g., an average) satisfies a threshold. If so, then the analysis module 310 may determine that the first machine learning algorithm/model is generating accurate predictions for the inference data set. In some embodiments, the health scores/values may include prediction confidence values, data deviation values, AB testing values, canary values, and/or the like.

Table 1 below illustrates an example output data set that the analysis module 310 may analyze to determine whether the first machine learning algorithm/model is a good fit for the inference data set:

TABLE 1
Classification
Logistic Regression

| | | Secondary algorithm | | | | Confusion Matrix [TN, FP | |
|---|---|---|---|---|---|---|---|
| | Primary | predicted accuracy | | ML_squared_error | | FN, TP] | |
| | algorithm | | with | | with | | with primary |
| Dataset | error | | primary predictions | | primary predictions | | predictions |
| Samsung | 0.92 | 0.92 | 0.92 | 0.88 | 0.88 | [63. 159.] | [60. 168.] |
| | | | | | | [183. 2542.] | [96. 2523.] |
| Yelp | 0.95 | 0.95 | 0.95 | 0.97 | 0.98 | [73. 21.] | [77. 20.] |
| | | | | | | [28. 1838.] | [23. 1840.] |
| Census | 0.78 | 0.63 | 0.64 | 0.79 | 0.8 | [2032. 1930.] | [2037. 1852.] |
| | | | | | | [360. 6532.] | [355. 6610.] |
| Forest | 0.65 | 0.64 | 0.59 | 0.73 | 0.74 | [42855. 27694.] | [48714. 30977.] |
| | | | | | | [24669. 98453.] | [18451. 95529.] |
| Letter | 0.71 | 0.6 | 0.62 | 0.80 | 0.84 | [1640. 1036.] | [1711. 806.] |
| | | | | | | [323. 3668.] | [276. 3874.] |

The primary algorithm error column, in one embodiment, comprises the prediction error of the first machine learning algorithm in performing the primary task of classification for a given data set. For example, the Samsung data set has six classes corresponding to human activity such as walking, standing, etc. The features for this data set may include values collected from a Samsung® phone. The first machine learning algorithm trains on these features and labels using the training data set to generate the first machine learning algorithm/model. Later, the first machine learning algorithm/model is used to predict labels using the features in validation data set. The primary validation module 304 compares the predictions made by the first machine learning algorithm/model to the true label of the validation data to calculate primary algorithm error values.

The secondary algorithm predicted accuracy column comprises the value of the predicted accuracy of the first machine learning algorithm by the second machine learning algorithm. In one embodiment, as an indicator of an accurate first machine learning algorithm/model, this value should be equal to, or substantially equal to, the value in the “Primary algorithm error” column. As explained above, the second machine learning algorithm receives features (e.g., of the inference data set, the error data set, and/or other features) as input and predicts whether the first machine learning algorithm is suitable for making accurate predictions on the inference data set. In one embodiment, the second machine learning algorithm detects samples where the first machine learning algorithm will be unsuccessful in making correct predictions. The sub-column “with primary predictions” includes values indicating the predicted accuracy of the first machine learning algorithm by the second machine learning algorithm that are calculated using the predicted values that the primary algorithm/model generates.

The values in the ML_squared_accuracy column, in one embodiment, describe the suitability of the second machine learning algorithm in making accurate predictions regarding the predictive performance of the first machine learning algorithm. In one embodiment, the secondary validation module 308 generates the values in the MLsquared_accuracy column. Sometimes the aggregate statistics might work out such that the columns “Primary algorithm error” and “Secondary algorithm predicted accuracy” match, but the individual predictions might be incorrect. For example, some 0's may be predicted as 1's and some 1's may be predicted as 0's (where 0 is a fail and 1 is a pass). The ML_squared_accuracy may be based on a sample by sample comparison to evaluate the predictive performance of the first machine learning algorithm. The sub-column “with primary predictions” includes values that describe the suitability of the second machine learning algorithm in making accurate predictions regarding the predictive performance of the first machine learning algorithm that are calculated using the predicted values that the primary algorithm/model generates.

In one embodiment, the confusion matrix column includes the confusion matrix values that the secondary validation module 308 generates for the second machine learning algorithm. In one embodiment, the ML_squared_accuracy and other predictive performance metrics can be calculated based on the values in the confusion matrix. The sub-column “with primary predictions” includes values indicating the validity of the second machine learning algorithm/model that are calculated using the predicted values that the primary algorithm/model generates.

In one embodiment, the analysis module 310 may determine whether the suitability score based on the metrics/health scores in Table 1 satisfies a threshold to determine (1) whether the second machine learning algorithm/model is a good fit for validating the predictive performance of the first machine learning algorithm/model, and if so (2) whether the first machine learning algorithm/model is a good fit for generating accurate predictions for the inference data set (in the absence of labels). In this manner, the ML management apparatus 104 can predict, in real time, the efficacy of a trained model on generating predictions for an inference data set while it is in production, instead of waiting minutes/hours/weeks/days/etc. to determine the predictive performance of the trained model, and if it determines that the trained model is not generating accurate predictions, the ML management apparatus 104 can react accordingly as described below with reference to the action module 312.

In one embodiment, the analysis module 310 may use additional data (e.g., in addition to the metrics/health scores in Table 1) to determine whether the first machine learning algorithm/model is suitable for the inference data. For instance, the analysis module 310 may receive or access data deviation information (e.g., as described in U.S. patent application Ser. No. 16/001,904, which is incorporated by reference herein in its entirety) to determine whether and how much the inference data differs from the training data that was used to train the first machine learning model. If the data deviation scores do not deviate beyond a predefined threshold, then the second machine learning algorithm/model may be used to determine the predictive performance of the first machine learning algorithm/model on the inference data because the first machine learning algorithm/model is suitable for the inference data set (e.g., the training data set and the inference data set are sufficiently similar or complementary). Otherwise, if the data deviation scores indicate that the inference data set is not similar enough to the training data set so that the first machine learning algorithm/model would likely not generate accurate predictions for the inference data set, the analysis module 310 may trigger one or more of the actions described below.

In one embodiment, the action module 312 is configured to trigger an action associated with the first machine learning algorithm, dynamically in real time, in response to the predicted suitability of the first machine learning algorithm/model for analyzing the inference data set not satisfying a predetermined suitability threshold. In one embodiment, the action comprises retraining the first machine learning model for the first machine learning algorithm using a different training data set. For instance, the action module 312 may select or trigger selection of a different training data set for retraining the first machine learning model.

In some embodiments, the action comprises switching the first machine learning model to a different machine learning model trained on different training data for the first machine learning algorithm. For instance, the action module 312 may select or trigger selection of a machine learning model that has been trained on different training data, which may be more suitable or similar to the inference data set.

In one embodiment, the action comprises recommending one or more different first machine learning algorithms for analyzing the inference data set. For instance, the action module 312 may generate a notification, message, or the like that includes a recommendation for a different machine learning algorithm that may be more suitable for the inference data set based on the characteristics or the inference data set.

In various embodiments, the action comprises updating one or more thresholds associated with determining the suitability of the first machine learning algorithm/model for analyzing the inference data set. For instance, the action module 312 may update or trigger updating suitability thresholds, e.g., the thresholds used to determine whether the first machine learning algorithm is suitable for the inference data set, to be more flexible or stringent. For example, if various first machine learning algorithms have been generated, but none of the first machine learning algorithms have a suitability score that satisfies the predefined threshold, then the threshold may be set too high, and the action module 312 may adjust the threshold until a suitable first machine learning algorithm is determined.

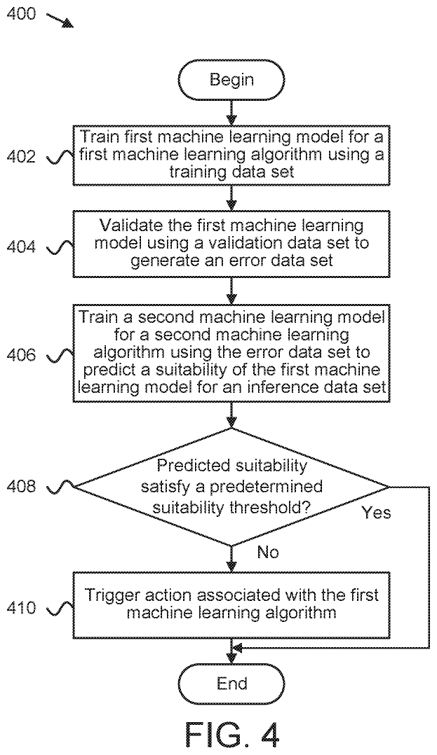

FIG. 4 is a schematic flow chart diagram illustrating one embodiment of a method 400 for determining validity of machine learning algorithms for datasets. In one embodiment, the method 400 begins, and the primary training module 302 trains 402 a first machine learning model for a first machine learning algorithm using a training data set. In further embodiments, the primary validation module 304 validates 404 the first machine learning algorithm/model using a validation data set. The output of the validation of the first machine learning algorithm/model may include an error data set.

In some embodiments, the secondary training module 306 trains 406 a second machine learning model for a second machine learning algorithm using the error data set. The second machine learning algorithm may be configured to predict a suitability of the first machine learning algorithm/model for analyzing an inference data set. In various embodiments, the analysis module 310 determines 408 whether the predicted suitability of the first machine learning algorithm/model satisfies a predetermined suitability threshold. If so, the method 400 ends. Otherwise, the action module 312 triggers 410 an action associated with the first machine learning algorithm, and the method 400 ends.

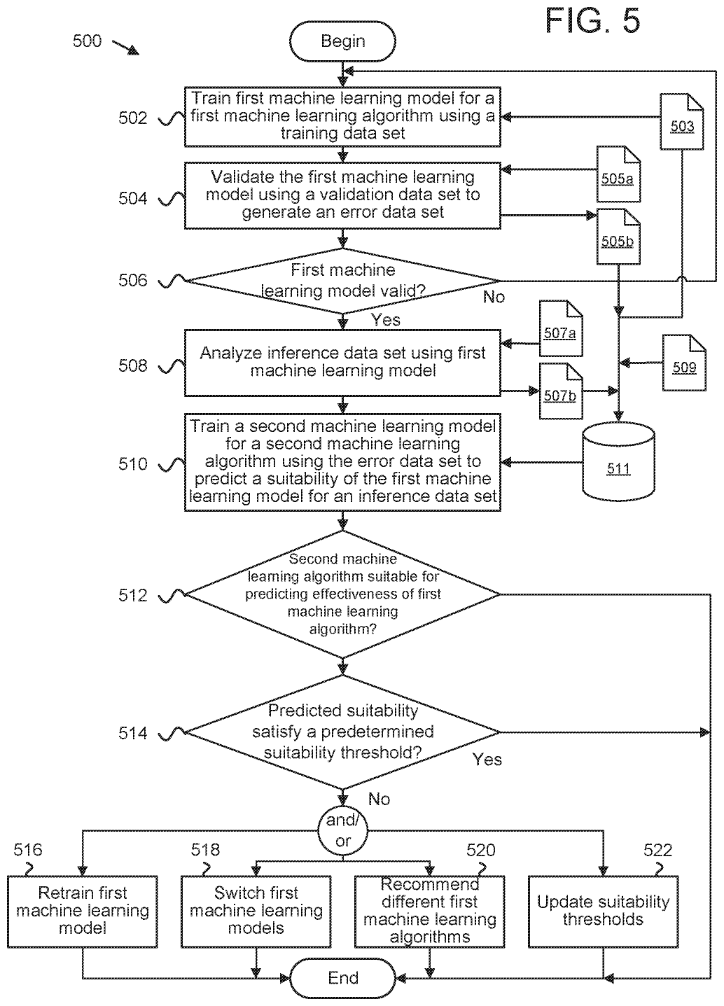

FIG. 5 is a schematic flow chart diagram illustrating another embodiment of a method 500 for determining validity of machine learning algorithms for datasets. In one embodiment, the method 500 begins, and the primary training module 302 trains 502 a first machine learning model for a first machine learning algorithm using a training data set 503. In further embodiments, the primary validation module 304 validates 504 the first machine learning algorithm/model using a validation data set 505a. The output of the validation of the first machine learning algorithm/model may include an error data set 505b.

In some embodiments, if the primary validation module 304 determines 506 that the first machine learning model is not a valid model, then the primary training module 302 may train 502 the machine learning model using a different training data set 503. Otherwise, the first machine learning model is used to analyze 508 an inference data set 507a to generate one or more predictions 507b for the inference data set. In certain embodiments, the training data set 503 that is used to train the first machine learning model, the error data set 505b, the generated one or more predictions 507b, and/or other statistical data (e.g., confidence values, data deviation values, AB testing values, canary values, other health scores, and/or the like) may be combined to generate an enhanced error data set 511 that is used to train the second machine learning model.

In one embodiment, the secondary training module 306 trains 510 a second machine learning model for a second machine learning algorithm using the enhanced error data set 511. The second machine learning algorithm may be configured to predict a suitability of the first machine learning algorithm/model for analyzing an inference data set. In one embodiment, the secondary validation module 308 determines 512 whether the second machine learning algorithm/model is suitable for the assessing the predictive performance of the first machine learning algorithm/model for the inference data set. If not, the method 500 ends.

Otherwise, the analysis module 310 determines 514 whether the predicted suitability of the first machine learning algorithm/model satisfies a predetermined suitability threshold. If so, the method 500 ends. Otherwise, the action module 312 triggers one or more actions associated with the first machine learning algorithm. For instance, the action module 312 may trigger retraining 516 the first machine learning model with different training data, may trigger switching 518 the first machine learning model to a different machine learning model that is trained using different training data, may recommend 520 different machine learning algorithms for analyzing the inference data set, may update 522 suitability thresholds, and/or the like, and the method 500 ends.

Means for training a first machine learning model for a first machine learning algorithm using a training data set includes, in various embodiments, one or more of an ML management apparatus 104, a primary training module 302, a device driver, a controller executing on a host computing device, a processor, an FPGA, an ASIC, other logic hardware, and/or other executable code stored on a computer-readable storage medium. Other embodiments may include similar or equivalent means for training a first machine learning model for a first machine learning algorithm using a training data set.

Means for validating the first machine learning model using a validation data set includes, in various embodiments, one or more of an ML management apparatus 104, a primary validation module 304, a device driver, a controller executing on a host computing device, a processor, an FPGA, an ASIC, other logic hardware, and/or other executable code stored on a computer-readable storage medium. Other embodiments may include similar or equivalent means for validating the first machine learning model using a validation data set.

Means for training a second machine learning model for a second machine learning algorithm using the error data set includes, in various embodiments, one or more of an ML management apparatus 104, a secondary training module 306, a device driver, a controller executing on a host computing device, a processor, an FPGA, an ASIC, other logic hardware, and/or other executable code stored on a computer-readable storage medium. Other embodiments may include similar or equivalent means for training a second machine learning model for a second machine learning algorithm using the error data set.

Means for triggering an action associated with the first machine learning algorithm in response to the predicted suitability of the first machine learning model for analyzing the inference data set not satisfying a predetermined suitability threshold includes, in various embodiments, one or more of an ML management apparatus 104, an action module 310, a device driver, a controller executing on a host computing device, a processor, an FPGA, an ASIC, other logic hardware, and/or other executable code stored on a computer-readable storage medium. Other embodiments may include similar or equivalent means for triggering an action associated with the first machine learning algorithm in response to the predicted suitability of the first machine learning model for analyzing the inference data set not satisfying a predetermined suitability threshold.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a primary training module configured to train a first machine learning model for a first machine learning algorithm using a training data set;
a primary validation module configured to validate the first machine learning model using a validation data set, the output of the validation of the first machine learning model comprising an error data set;
a secondary training module configured to train a second machine learning model for a second machine learning algorithm using the error data set, the second machine learning algorithm configured to predict a suitability of the first machine learning model for analyzing an inference data set; and
an action module configured to trigger an action associated with the first machine learning algorithm in response to the predicted suitability of the first machine learning model for analyzing the inference data set not satisfying a predetermined suitability threshold.

2. The apparatus of claim 1, further comprising a secondary validation module configured to determine a suitability of the second machine learning algorithm for predicting the suitability of the first machine learning algorithm.

3. The apparatus of claim 2, wherein the secondary validation module uses one or more of a confusion matrix and one or more training statistics to determine the suitability of the second machine learning algorithm for predicting the suitability of the first machine learning algorithm.

4. The apparatus of claim 1, wherein the secondary training module is further configured to train a plurality of different second machine learning models and generate an ensemble of second machine learning models, the ensemble configured to predict the suitability of the first machine learning model for analyzing the inference data set.

5. The apparatus of claim 1, wherein the suitability of the first machine learning model for analyzing an inference data set comprises one or more health values that indicate the suitability of the first machine learning model in generating accurate predictions for the inference data set, the action module triggering the action, in real time during production, based on the one or more health values.

6. The apparatus of claim 5, wherein the one or more health values comprise one or more of prediction confidence values, data deviation values, AB testing values, and canary values.

7. The apparatus of claim 1, wherein the action comprises retraining the first machine learning model for the first machine learning algorithm using a different training data set.

8. The apparatus of claim 1, wherein the action comprises switching the first machine learning model to a different machine learning model trained on different training data for the first machine learning algorithm.

9. The apparatus of claim 1, wherein the action comprises recommending one or more different first machine learning algorithms for analyzing the inference data set.

10. The apparatus of claim 1, wherein the action comprises updating one or more thresholds associated with determining the suitability of the first machine learning model for analyzing the inference data set.

11. The apparatus of claim 1, wherein the error data set comprises:
labels that comprise errors generated from the predictions of the first machine learning model on the validation data set, the errors comprising values indicating pass/fail criteria for the first machine learning model; and
features that comprise one or more of features of the error data set, statistical signature scores of each sample in the error data set, prediction values generated by the first machine learning model, confidence metrics associated with predictions of the first machine learning model, and one or more parameters specific to the first machine learning model.

12. The apparatus of claim 11, wherein the training data set comprises continuous labels, and the error values indicating pass/fail criteria are determined based on a regression algorithm that determines a distance of a predicted value from a true label, the error values comprising pass values in response to the determined distance satisfying a threshold distance.

13. The apparatus of claim 12, wherein the threshold distance is determined by generating a regression error characteristic (“REC”) curve for the validation data set using the first machine learning algorithm.

14. A method comprising:
training a first machine learning model for a first machine learning algorithm using a training data set;
validating the first machine learning model using a validation data set, the output of the validation of the first machine learning model comprising an error data set;
training a second machine learning model for a second machine learning algorithm using the error data set, the second machine learning algorithm configured to predict a suitability of the first machine learning model for analyzing an inference data set; and
triggering an action associated with the first machine learning algorithm in response to the predicted suitability of the first machine learning model for analyzing the inference data set not satisfying a predetermined suitability threshold.

15. The method of claim 14, further comprising determining a suitability of the second machine learning algorithm for analyzing predicting the suitability of the first machine learning algorithm using one or more of a confusion matrix and one or more training statistics to determine the suitability of the second machine learning algorithm for predicting the suitability of the first machine learning algorithm.

16. The method of claim 14, further comprising training a plurality of different second machine learning models and generate an ensemble of second machine learning models, the ensemble configured to predict the suitability of the first machine learning model for analyzing the inference data set.

17. The method of claim 14, wherein the suitability of the first machine learning model for analyzing an inference data set comprises one or more health values that indicate the suitability of the first machine learning model in generating accurate predictions for the inference data set, the action triggered in real time during production based on the one or more health values.

18. The method of claim 14, wherein the action comprises one of more of:
retraining the first machine learning model for the first machine learning algorithm using a different training data set;
switching the first machine learning model to a different machine learning model trained on different training data for the first machine learning algorithm;
recommending one or more different first machine learning algorithms for analyzing the inference data set; and
updating one or more thresholds associated with determining the suitability of the first machine learning model for analyzing the inference data set.

19. The method of claim 14, wherein the error data set comprises:
labels that comprise errors generated from the predictions of the first machine learning model on the validation data set, the errors comprising values indicating pass/fail criteria for the first machine learning model; and
features that comprise one or more of features of the error data set, statistical signature scores of each sample in the error data set, prediction values generated by the first machine learning model, confidence metrics associated with predictions of the first machine learning model, and one or more parameters specific to the first machine learning model.

20. An apparatus comprising:
means for training a first machine learning model for a first machine learning algorithm using a training data set;
means for validating the first machine learning model using a validation data set, the output of the validation of the first machine learning model comprising an error data set;
means for training a second machine learning model for a second machine learning algorithm using the error data set, the second machine learning algorithm configured to predict a suitability of the first machine learning model for analyzing an inference data set; and
means for triggering an action associated with the first machine learning algorithm in response to the predicted suitability of the first machine learning model for analyzing the inference data set not satisfying a predetermined suitability threshold.
